(19) United States
(12) Patent Application Publication
(10) Pub. No.: US 2009/0056485 A1
(43) Pub. Date: Mar. 5, 2009

(54) Method of Connecting and Fixing Ball Screw Shaft to Motor Shaft

(76) Inventors: Kiyoto Kobayashi, Nagano (JP); Akihiro Yokoyama, Nagano (JP)

Correspondence Address: FLYNN THIEL BOUTELL & TANIS, P.C., 2026 RAMBLING ROAD, KALAMAZOO, MI, 49008-1631, US

(21) Appl. No.: 11/918,635

(22) PCT Filed: May 23, 2005
(86) PCT No.: PCT/JP2005/009333

§ 371 Date: Oct. 15, 2007

(51) Int. Cl. F16H 25/20; F16B 7/00

(52) U.S. Cl. 74/22 R; 403/296

(57) ABSTRACT

A motor (2) of a linear motion device (1) has a hollow motor shaft (21). A ball screw shaft (41) is inserted in a hollow section (25) of the hollow motor shaft (21), and a first male screw section (43), formed on the outer periphery of the ball screw shaft, is screwed into a female screw section (26), formed in the inner periphery of the hollow section, and fixed in position. A nut (46) is crewed on a second male screw section (45) formed on a shaft end section (44) of the ball screw shaft (41) that projects from the rear end of the hollow motor shaft, and the nut (46) is tightened at predetermined torque to a rear end face of the hollow motor shaft. Tensile force occurring between the first male screw section (43) and second male screw section (45) of the ball screw shaft (41) prevents loosening of the screwed section between the hollow motor shaft (21) and the ball screw shaft (41), and, as a result, the ball screw shaft (41) is kept firmly fixed to the hollow motor shaft (21) without having play. Removal of the ball screw shaft (41) from the hollow motor shaft (21) is also simple.

### TECHNICAL FIELD

The present invention relates to a linear motion device for rotating a ball screw shaft by a motor to linearly move a ball nut, and more particularly to an improvement of a method of connecting and fixing a ball screw shaft to a motor shaft in a coaxial state.

### BACKGROUND ART

In this type of linear motion device, a key groove or spline groove is machined in a ball screw shaft and motor shaft, and these are connected in a coaxial state. A fixing screw is used to fix a key connection section or a spline connection section between the motor shaft and the ball screw shaft.

In this method, when the fixing screw loosens due to the vibration of the ball screw shaft or other such causes, the key connection section or spline connection section might develop some play in the rotation direction or axial direction.

It is suggested that to prevent any play from occurring in the connection section between the motor shaft and ball screw shaft, the motor shaft and the ball screw shaft must be connected and fixed in a press-fitted state. However, a separate problem is encountered in this case, whereby the motor shaft and the ball screw shaft are difficult to disassemble.

### DISCLOSURE OF THE INVENTION

An object of the present invention is to provide a method of connecting and fixing a ball screw shaft to a motor shaft so that a play-free connection state can be maintained and disassembly can be performed in a simple manner.

Another object of the present invention is to provide a motor with a built-in ball screw shaft in which the ball screw shaft is connected and fixed to a motor shaft so that a play-free connection state can be maintained and disassembly can be performed in a simple manner.

Yet another object of the present invention is to provide a linear motion device in which a ball screw shaft is connected and fixed to a motor shaft so that a play-free connection state can be maintained and disassembly can be performed in a simple manner.

To achieve the above objects, the method of connecting and fixing a ball screw shaft to a motor shaft in a coaxial state according to the present invention is characterized in comprising the steps of:
providing a motor shaft as a hollow motor shaft;
inserting the ball screw shaft into a hollow section of the hollow motor shaft, and screwing and fixing in position a first male screw section formed on the outer periphery of the ball screw shaft into a female screw section formed on the inner periphery of the hollow section;
extending a shaft end section of the ball screw shaft from one end of the hollow motor shaft;

screwing a nut on a second male screw section formed on the shaft end section, and tightening the nut at a predetermined torque to an end face of the hollow motor shaft; and
using a tensile force generated between the first male screw section and the second male screw section of the ball screw shaft to prevent loosening of the screwed section between the hollow motor shaft and the ball screw shaft.

The motor with a built-in ball screw shaft according to the present invention is characterized in that the ball screw shaft is fixed to the motor shaft by the above-described method.

The linear motion device in which a ball screw shaft is rotated by a motor, and a ball nut is linearly moved, according to the present invention is characterized in that the ball screw shaft is fixed to the motor shaft by the above-described method.

In the method of the present invention, a ball screw shaft is screwed in and fixed in position to a hollow motor shaft, and a nut screwed onto a shaft end section of the ball screw shaft extending from one end of the hollow motor shaft is tightened to the hollow motor shaft. The screwed section between the hollow motor shaft and ball screw shaft is brought into a state in which pressure is applied in the axial direction by the tensile force exerted on the ball screw shaft by the tightening of the nut. Similarly, the nut and the screwed section of the shaft end section of the ball screw shaft are brought into a state in which pressure is applied in the axial direction. As a result, a state is maintained in which loosening of the screwed section is prevented and the ball screw shaft is securely connected and fixed to the hollow motor shaft without any play. The ball screw shaft can be disassembled from the hollow motor shaft in a simple manner by loosening the nut, removing the nut from the end shaft section of the ball screw shaft, and then loosening the ball screw shaft and removing the shaft from the hollow motor shaft. Furthermore, the threading costs are lower compared to keying or splining, making this approach useful in reducing the costs of linear motion devices and motors with a built-in ball screw shaft.

### BRIEF DESCRIPTION OF THE DRAWINGS

FIG. 1 is a vertical cross-sectional schematic view showing a linear motion device to which the present invention is applied.

### BEST MODE FOR CARRYING OUT THE INVENTION

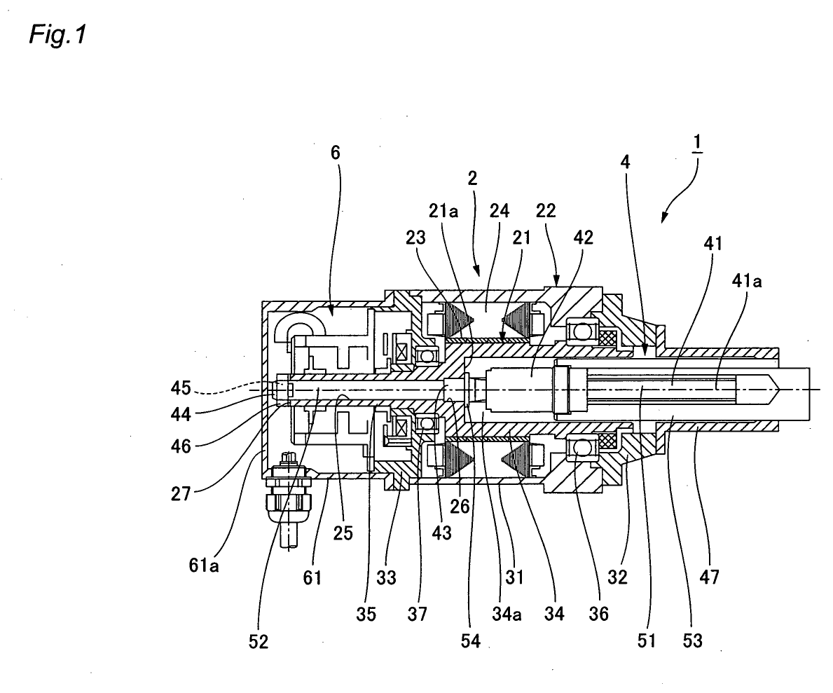

A description is provided hereunder of one example of a linear motion device to which the present invention has been applied, with reference being made to the accompanying drawings. FIG. 1 is a vertical cross-sectional schematic view showing the linear motion device of the present example. A linear motion device 1 has a motor 2, a ball screw/ball nut mechanism 4 connected to the motor 2 in a coaxial state, and a detector 6 incorporated into the rear of the motor 2. The detector 6 comprises a rotary encoder or the like and obtains the rotating position, rotating speed, and other types of rotational information about the motor 2.

The motor shaft of the motor 2 is a hollow motor shaft 21, and the shaft is supported in a rotatable state by a motor housing 22. A rotor magnet 23 is fixed to the outer periphery of the hollow motor shaft 21. A motor stator 24 is attached to the inner periphery of the motor housing 22 in a state in which the stator encloses the rotor magnet 23 across a set gap.

The ball screw/ball nut mechanism 4 has a ball screw shaft 41, and a ball nut 42 screwed onto the ball screw shaft 41. The ball screw shaft 41 is connected and fixed in a coaxial state to the hollow motor shaft 21. The ball nut 42 is mounted to the motor housing 22 in a state in which the nut cannot rotate but can slide in the direction of an axial line 41a of the ball screw shaft 41. Accordingly, rotation of the ball screw shaft 41 by the motor 2 causes the ball nut 42 to slide in the direction of the axial line 41a.

The ball screw shaft 41 is connected and fixed to the hollow motor shaft 21 in the following manner. The ball screw shaft 41 is inserted into a hollow section 25 of the hollow motor shaft 21, and a first male screw section 43 formed on the outer periphery of the ball screw shaft 41 is screwed in and fixed to a female screw section 26 formed on the inner periphery of the hollow section 25. A shaft end section 44 of the ball screw shaft 41 is extended from the rear end of the hollow motor shaft 21; and a second male screw section 45 is formed on the outer periphery section of the shaft end section 44. A nut 46 screwed onto the second male screw section 45 is tightened against a rear end face 27 of the hollow motor shaft 21 with a predetermined torque.

When the nut 46 is tightened, a tensile force of a predetermined magnitude is generated between the first male screw section 43 and the second male screw section 45, which are separated in the axial direction in the ball screw shaft 41. The generated tensile force prevents the loosening of the screwed section composed of the first male screw section 43 and the female screw section 26. The loosening of the screwed section composed of the second male screw section 45 and the nut 46 is prevented in the same manner. Accordingly, the ball screw shaft 41 is maintained in a state whereby the shaft is connected and fixed to the hollow motor shaft 21 without any play.

Next, the structure of each section is described in detail. The motor housing 22 is composed of a cylindrical trunk section 31, an annular front plate 32 fixed to the annular front end face of the cylindrical trunk section 31, and an annular rear plate 33 fixed to an annular rear end face of the cylindrical trunk section 31. A cylindrical cover 47 of the ball screw/ball nut mechanism 4 is attached to the front end face of the annular front plate 32. A cylindrical cover 61 of the detector 6 is attached to the rear end face of the annular rear plate 33; and the rear end of the cylindrical cover 61 is sealed by an end plate section 61a.

The hollow motor shaft 21, which coaxially extends through the motor housing 22, is composed of a large-diameter shaft section 34 attached to the rotor magnet 23, and a small-diameter shaft section 35 that extends rearward in a coaxial state from the rear end of the large-diameter shaft section 34. The front end-side section of the large-diameter shaft section 34 is supported by the front end section of the cylindrical trunk section 31 via a bearing 36; and the front end-side section of the small-diameter shaft section 35 is supported by the annular rear plate 33 via a bearing 37.

The ball screw shaft 41 has a shaft main section 51 provided with a ball screw groove, and a connection shaft section 52 extending rearward in a coaxial state from the rear end of the shaft main section 51. The main shaft section 51 extends in a coaxial state inside a hollow section 34a of the large-diameter shaft section 34 of the hollow motor shaft 21, and the front end reaches the front end orifice of the cylindrical cover 47. The ball nut 42 is screwed onto the shaft main section 51; and a shaft member 53, which is held so as to be non-rotatable but be able to slide in the direction of the axial line 41a by the motor housing 22, is coaxially connected to the ball nut 42. As can be seen from the figure, in the present example, the ball nut 42 is able to move inside the hollow section 34a of the large diameter section 34 of the hollow motor shaft 21. Consequently, the required shaft length can be reduced in comparison with a case of securing the movement locus of the ball nut 42 having a set length in front of the motor 2.

Next, the connection shaft section 52 of the ball screw shaft 41 has an outside diameter dimension at which the small-diameter shaft section 35 of the hollow motor shaft 21 can be inserted into the hollow section 25, and a slightly larger-diameter stepped surface formed at the boundary with the large diameter shaft section 34 is screwed in until pushed against an annular stepped surface 21 a of the inner section of the hollow motor shaft 21 via a stopping ring 54. Specifically, the first male screw section 43 is formed on the rear side of the annular stepped surface 21a, the female screw section 26 is formed on the inner periphery of the front end section in the hollow section 25 of the small-diameter shaft 35 of the hollow motor shaft 21, and the first male screw section 43 is screwed and fixed in the female screw section 26.

The shaft end section 44 on the rear side of the connection shaft section 52 of the ball screw shaft 41 is extended rearward from the rear end of the hollow section 25 of the small-diameter shaft section 35 of the hollow motor shaft 21, and the second male screw section 45 is formed on the outer periphery of the shaft end section 44. The nut 46 is screwed into the second male screw section 45 from the rear side, and the nut 46 is tightened to the annular rear end face 27 of the connection shaft section 52 by a predetermined tightening torque.

In the linear motion device 1 of the present example thus configured, the connection shaft section 52 of the ball screw shaft 41 is screwed and fixed in the hollow section 25 of the small-diameter shaft section 35 of the hollow motor shaft 21. Also, the nut 46 is tightened to the shaft end section 44 of the ball screw shaft 41 that protrudes from the rear end of the small-diameter shaft section 35. Consequently, the connection shaft section 52 of the ball screw shaft 41 is screwed in and fixed in the small-diameter shaft section 35 of the hollow motor shaft 21 in the two regions of the front end and rear end, and a tensile force acts on the section between these two regions of the ball screw shaft 41.

As a result, the ball screw shaft 41 is thereby securely connected and fixed to the hollow motor shaft 21 without any play. Also, the ball screw shaft 41 can be loosened and disassembled from the hollow motor shaft 21 in a simple manner after the nut 46 is loosened and removed. An additional advantage is that the threading cost is lower than that of keying or splining, and can therefore be used to reduce the cost of the linear motion device 1.

### OTHER EMBODIMENTS

In the above example, the hollow motor shaft 21 is formed with the large-diameter shaft section 34 and the small-diameter shaft section 35, and the inside of the hollow section 34a of the large-diameter shaft 34 is used as the movement path for the ball nut 42. It is apparent, however, that the present invention can be applied in the same manner to a linear motion device structured so that the movement path of the ball nut 42 is formed in front of the motor rather than inside the motor.

1. A method for connecting and fixing a ball screw shaft to a motor shaft in a coaxial state, the method for connecting and fixing a ball screw shaft to a motor shaft is characterized in comprising the steps of:
providing a motor shaft as a hollow motor shaft;
inserting a ball screw shaft into a hollow section of the hollow motor shaft, and screwing and fixing in position a first male screw section formed on an outer periphery of the ball screw shaft into a female screw section formed on an inner periphery of the hollow section;
extending a shaft end section of the ball screw shaft from one end of the hollow motor shaft;
screwing a nut on a second male screw section formed on the shaft end section, and tightening the nut at a predetermined torque to an end face of the hollow motor shaft; and
using a tensile force generated between the first male screw section and the second male screw section of the ball screw shaft to prevent loosening of a screwed section between the ball screw shaft and the hollow motor shaft.

2. A motor with a built-in ball screw shaft, characterized in that the ball screw shaft is fixed to the motor shaft by the method according to claim 1.

3. A linear motion device in which a ball screw shaft is rotated by a motor, and a ball nut is linearly moved, characterized in that the ball screw shaft is fixed to the motor shaft by the method according to claim 1.
